(19) United States
(12) Patent Application Publication
(10) Pub. No.: US 2017/0337390 A1
(43) Pub. Date: Nov. 23, 2017

(54) DATA PROTECTION AT FACTORY RESET

(71) Applicant: QUALCOMM Incorporated, San Jose, CA (US)

(72) Inventors: Anthony John HAMILTON, Salisbury (GB); Christian BOLIS, Farnborough (GB); Nicholas TEBBIT, Old Windsor (GB); Jeremy Robin Christopher O'DONOGHUE, Wokingham (GB)

(21) Appl. No.: 15/157,721

(22) Filed: May 18, 2016

(51) Int. Cl. G06F 21/62; G06F 21/74; G06F 21/79; H04L 9/08

(52) U.S. Cl. CPC G06F 21/6218; H04L 9/0861; G06F 21/74; G06F 21/79

(57) ABSTRACT

Methods, apparatus, and computer program products for protecting information stored on a computing device are described. An example of a method includes generating a first encryption key based on a previously stored factory reset value, encrypting, by a processor, at least a portion of information associated with an application using the first encryption key, storing the encrypted at least the portion of the information associated with the application in a memory of the computing device, obtaining, by the processor, a request for a factory reset of the computing device, in response to the request for the factory reset of the computing device, replacing, by the processor, the previously stored factory reset value with a new factory reset value, and disabling decryption of the stored encrypted at least the portion of the information associated with the application by generating a second encryption key based on the new factory reset value.

### BACKGROUND

User data may persist on a computing device after factory reset process is performed on the computing device. For example, a power failure during a factory reset process may cause only a portion of the user data to be removed from the computing device. As another example, in a replay attack, a malicious party may copy the user data to a remote storage location prior to or during the factory reset process. Following the factory reset process, the malicious party may restore the user data to the computing device. User data persisting on the computing device after the factory reset process may be vulnerable to misuse and/or may enable violation of privacy rules associated with the user data. Further, the factory reset process may not provide attestation that the user data targeted for removal by the factory reset process is in fact inaccessible after the factory reset process. Such a lack of attestation may have adverse privacy, security, and/or legal consequences for a device user or administrator.

### SUMMARY

An example of a method of protecting information stored on a computing device according to the disclosure includes generating a first encryption key based on a previously stored factory reset value, encrypting, by a processor, at least a portion of information associated with an application using the first encryption key, storing the encrypted at least the portion of the information associated with the application in a memory of the computing device, obtaining, by the processor, a request for a factory reset of the computing device, in response to the request for the factory reset of the computing device, replacing, by the processor, the previously stored factory reset value with a new factory reset value, and disabling decryption of the stored encrypted at least the portion of the information associated with the application by generating a second encryption key based on the new factory reset value.

Implementations of such a method may include one or more of the following features. The previously stored factory reset value and the new factory reset value may each be a factory reset counter value, a random number, or a combination thereof. The method may further include generating the previously stored factory reset value and the new factory reset value by a trusted execution environment (TEE) of the processor and storing the previously stored factory reset value and the new factory reset value, by the TEE, in a secure portion of the memory. The information associated with the application may be user information and OEM information and the method may further include generating a third encryption key based on key material that excludes the previously stored factory reset value, encrypting the OEM information using the third encryption key, and encrypting the user information using the first encryption key. The method may further include, subsequent to the factory reset of the computing device, decrypting the OEM information using the third encryption key, attempting to decrypt the user information using the second encryption key, and generating an indication of non-decryptable user information in response to the attempting to decrypt the user information using the second encryption key. Obtaining the request for the factory reset of the computing device may include receiving a remote factory reset signal from a remote server. Obtaining the request for the factory reset of the computing device may include receiving a local factory reset signal generated at the computing device. The method may further include rebooting the computing device in response to obtaining the request for the factory reset of the computing device and replacing the previously stored factory reset value during the rebooting the computing device.

An example of a computing device configured to protect information stored on the computing device includes a memory and a processor communicatively coupled to the memory, the processor configured to generate a first encryption key based on a previously stored factory reset value, encrypt at least a portion of information associated with an application using the first encryption key, store the encrypted at least the portion of the information associated with the application in the memory, obtain a request for a factory reset of the computing device, in response to the request for the factory reset of the computing device, replace the previously stored factory reset value with a new factory reset value, and generate a second encryption key based on the new factory reset value wherein the generation of the second encryption key based on the new factory reset value disables decryption of the stored encrypted at least the portion of the information associated with the application.

Implementations of such a computing device may include one or more of the following features. The previously stored factory reset value and the new factory reset value may each be a factory reset counter value, a random number, or a combination thereof. The processor may include a trusted execution environment (TEE) configured to generate the previously stored factory reset value and the new factory reset value and store the previously stored factory reset value and the new factory reset value in a secure portion of the memory, wherein the secure portion of the memory comprises one-time writable memory devices. The processor may include a trusted execution environment (TEE) configured to generate the previously stored factory reset value and the new factory reset value and store the previously stored factory reset value and the new factory reset value in a secure portion of the memory, wherein the secure portion of the memory comprises a replay protected memory block (RPMB). The information associated with the application may include user information and OEM information and the processor may be further configured to generate a third encryption key based on key material that excludes the previously stored factory reset value, encrypt the OEM information using the third encryption key, and encrypt the user information using the first encryption key. The processor may be further configured to, subsequent to the factory reset of the computing device decrypt the OEM information using the third encryption key, attempt to decrypt the user information using the second encryption key, and generate an indication of non-decryptable user information in response to the attempt to decrypt the user information using the second encryption key. The processor may include a hardware embedded cryptographic driver configured to obtain encryption key material, wherein the encryption key material includes the previously stored factory reset value or the new factory reset value and provide the encryption key material to an encryption key derivation circuit. The processor may be further configured to reboot the computing device in response to the request for the factory reset of the computing device and replace the previously stored factory reset value during the reboot of the computing device.

An example of a non-transitory, processor-readable storage medium having stored thereon processor-readable instructions for protecting information stored on a computing device according to the disclosure includes processor-readable instructions configured to cause a processor to generate a first encryption key based on a previously stored factory reset value, encrypt at least a portion of information associated with an application using the first encryption key, store the encrypted at least the portion of the information associated with the application in a memory, obtain a request for a factory reset of the computing device, in response to the request for the factory reset of the computing device, replace the previously stored factory reset value with a new factory reset value, and generate a second encryption key based on the new factory reset value, wherein the generation of the second encryption key based on the new factory reset value disables decryption of the stored encrypted at least the portion of the information associated with the application.

Implementations of such a storage medium may include one or more of the following features. The processor-readable instructions may be further configured to cause the processor to generate the previously stored factory reset value and the new factory reset value by a trusted execution environment (TEE) of the processor and store the previously stored factory reset value and the new factory reset value, by the TEE, in a secure portion of the memory. The information associated with the application may include user information and OEM information and the processor-readable instructions may be further configured to cause the processor to generate a third encryption key based on key material that excludes the previously stored factory reset value, encrypt the OEM information using the third encryption key, encrypt the user information using the first encryption key, and subsequent to the factory reset of the computing device, decrypt the OEM information using the third encryption key, attempt to decrypt the user information using the second encryption key, and generate an indication of non-decryptable user information in response to the attempt to decrypt the user information using the second encryption key. The processor-readable instructions may include pre-boot loader instructions, boot loader instructions, operating system kernel instructions, and operating system instructions and at least one of the pre-boot loader instructions, the boot loader instructions, the operating system kernel instructions, or the operating system instructions may include instructions to replace the previously stored factory reset value during a reboot of the computing device in response to the request for the factory reset of the computing device.

Items and/or techniques described herein may provide one or more of the following capabilities. A hardware embedded cryptographic driver of a trusted execution environment (TEE) or other secure element of an electronic device may access a factory reset value (FR value) previously stored in a secure memory location. An encryption key derivation circuit operably coupled to the hardware embedded cryptographic driver may output a first encryption key based at least in part on the previously stored FR value. Prior to a factory reset process, the TEE may encrypt information associated with an application, using the first encryption key based at least in part on the previously stored FR value. The TEE may store the encrypted information in a memory of the computing device. During the factory reset process, the computing device may change the previously stored FR value to a new FR value and may erase all or a portion of the stored encrypted information from the device. The change in the FR value may change the output of the encryption key derivation circuit to a second encryption key. The first encryption key generated prior to the factory reset may effectively expire and the second encryption key may replace the expired first encryption key. Information encrypted prior to the factory reset may persist on the device despite the factory reset process. However, because the change in the FR value changes the encryption key, this encrypted information may be non-decryptable, and therefore inaccessible, after the factory reset process. As such, the computing device may provide the capability of disabling decryption after the factory reset process of information encrypted prior to the factory reset process even if the information persists on the device. Further, disabling decryption in this manner may provide the advantage of eliminating a reliance on erasure of data from the computing device to provide data security. Disabling decryption in a manner according to the disclosure may provide an attestation that encrypted information is inaccessible after a factory reset. The attestation may satisfy GlobalPlatform® requirements for inaccessibility of user information following a hard reset. The cryptographic driver may determine multiple and different encryption keys. The encryption key for user information may be based on the FR value while the encryption key for original equipment manufacturer (OEM) information may be not be based on the FR value. Therefore, the OEM information may be decryptable after the factory reset process. In this manner, the computing device may provide the capability of disabling decryption after the factory reset process of user information while enabling decryption of the OEM information after the factory reset process.

Other capabilities may be provided and not every implementation according to the disclosure must provide any, let alone all, of the capabilities discussed. Further, it may be possible for an effect noted above to be achieved by means other than that noted and a noted item/technique may not necessarily yield the noted effect.

### BRIEF DESCRIPTIONS OF THE DRAWINGS

FIG. 1 is a schematic diagram of an example of a communication system.

FIG. 2 is a block diagram of hardware components of the computing device of FIG. 1.

FIG. 3 is a block diagram of an example of a factory reset process.

FIGS. 4a and 4b are examples of encryption key derivation systems.

FIG. 5 is a block diagram of an example of a method of protecting information stored on a computing device.

FIG. 6 is a block diagram of an example of a system architecture for secure communications between a server and a computing device.

FIG. 7 is a block diagram of an example of an execution environment architecture for implementing data protection according to the disclosure.

### DETAILED DESCRIPTION

Techniques are provided for protecting information stored on a computing device. An encryption key derivation circuit of the computing device generates a first data storage encryption key based on a previously stored factory reset value (FR value) (e.g., a random number and/or a factory reset counter). The processor of the computing device encrypts information using the first encryption key based on the previously stored FR value. The processor stores the encrypted information in a memory of the computing device. In response to a request for the factory reset, the processor changes the previously stored FR value to a new FR value. As a result, the first encryption key based on the previously stored FR value is replaced by a second encryption key based on the new FR value. The change in the FR value and the resulting replacement of the data storage encryption key based on the FR value disables decryption of the stored encrypted information. The first encryption key may cease to exist on the computing device and information encrypted with the first encryption key may be non-decryptable with the second encryption key. The stored encrypted information may persist on and/or be restored to the computing device despite the implementation of a factory reset process configured to permanently erase such information from the computing device.

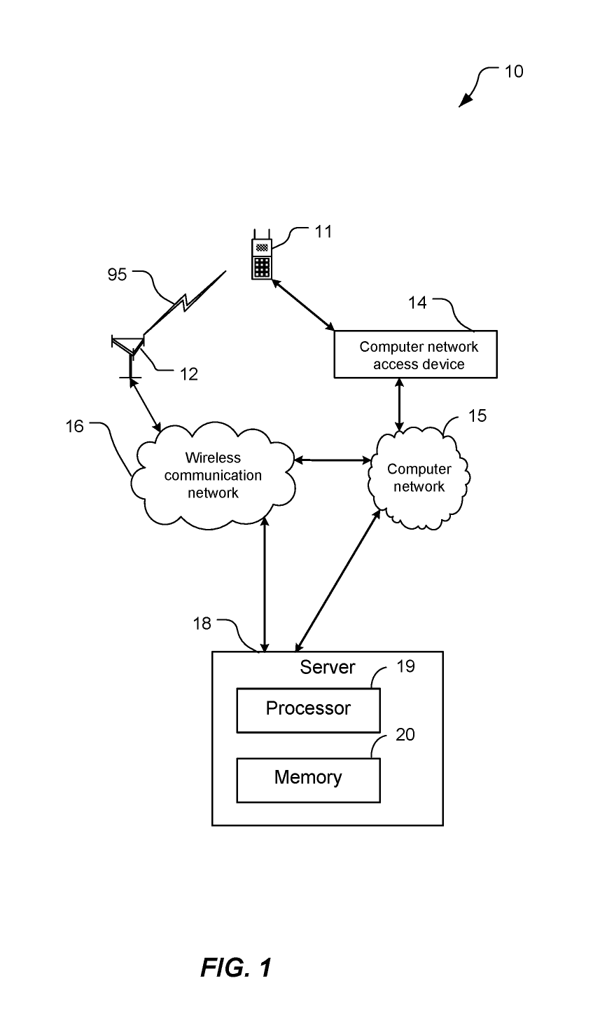

Referring to FIG. 1, a schematic diagram of an example of a communication system 10 is shown. The communication system 10 includes a computing device 11, a communication network access device 12, a computer network access device 14, a computer network 15, a wireless communication network 16, and a server 18. The quantity of each component in FIG. 1 is an example only and other quantities of each, or any, component could be used.

The computing device 11 is an electronic computing device and/or system. Although shown as a mobile phone in FIG. 1, the computing device 11 may be another electronic device. Examples of the computing device 11 include, for example but not limited to, an integrated circuit, a mainframe, a mini-computer, a server, a workstation, a set-top box, a personal computer, a laptop computer, a mobile device, a hand-held device, a wireless device, a navigation device, an entertainment appliance, a tablet, a modem, an electronic reader, a personal digital assistant, an electronic game, an automobile, an aircraft, a machinery, or combinations thereof. Claimed subject matter is not limited to a particular type, category, size, etc., of computing device.

The communication network access device 12 may be a base station, an access point, a femto base station, etc. The base station may also be referred to as, for example, a NodeB or an eNB (e.g., in the context of an LTE wireless network), etc. The communication network access device 12 may transmit network signals 95 for use in wireless network communications. The computer network access device 14 may be a router and/or cable modem communicatively coupled to the computing device 11 and the computer network 15. The computer network 15 may include a mobile switching center and a packet data network (e.g., an Internet Protocol (IP) network referred to herein as the Internet). Although shown separately, the computer network 15 may be a portion of the wireless communication network 16.

The wireless communication network 16 may be communicatively coupled to the computing device 11, the communication network access device 12, the computer network 15, and/or the server 18. The wireless communication network 16 may include, but is not limited to, a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMax, Ultra Mobile Broadband (UMB), and/or the like.

The server 18 may be, for example, but not limited to, a network server, a positioning server, an enterprise server, a server associated with a particular website and/or application, a cloud network server, or combinations thereof. Although only one server 18 is shown in FIG. 1 for simplicity, other quantities of servers (e.g., one or more servers or a plurality of servers) could be used. The server 18 is a computing device including at least one processor and a memory and is configured to execute computer executable instructions. For example, the server 18 may be a computer system including a processor 19 and a non-transitory memory 20. The processor 19 is preferably an intelligent device, e.g., a personal computer central processing unit (CPU) such as those made by Intel® Corporation or AMD®, a microcontroller, an application specific integrated circuit (ASIC), etc. The memory 20 includes a non-transitory, processor-readable storage medium that stores processor executable and processor-readable instructions (i.e., software code) that are configured to, when executed, cause the processor 19 to perform various functions as may be described herein (although the description may refer only to the processor 19 performing the functions). The memory 20 may include random access memory (RAM) and read-only memory (ROM). The wireless communication network 16 and/or the computer network 15 may communicatively couple the server 18 to the computing device 11. For example, the communication network access device 12 and/or the computer network access device 14 may communicate with the server 18 and retrieve information for use by the computing device 11. The configuration of the server 18 as a remote server is exemplary only and not a limitation. In an embodiment, the server 18 may be connected directly to the communication network access device 12, or the functionality may be included in the communication network access device 12. The server 18 may include one or more databases. In an example, the server 18 is comprised of multiple server units. The multiple server units may be administered by one or more enterprises.

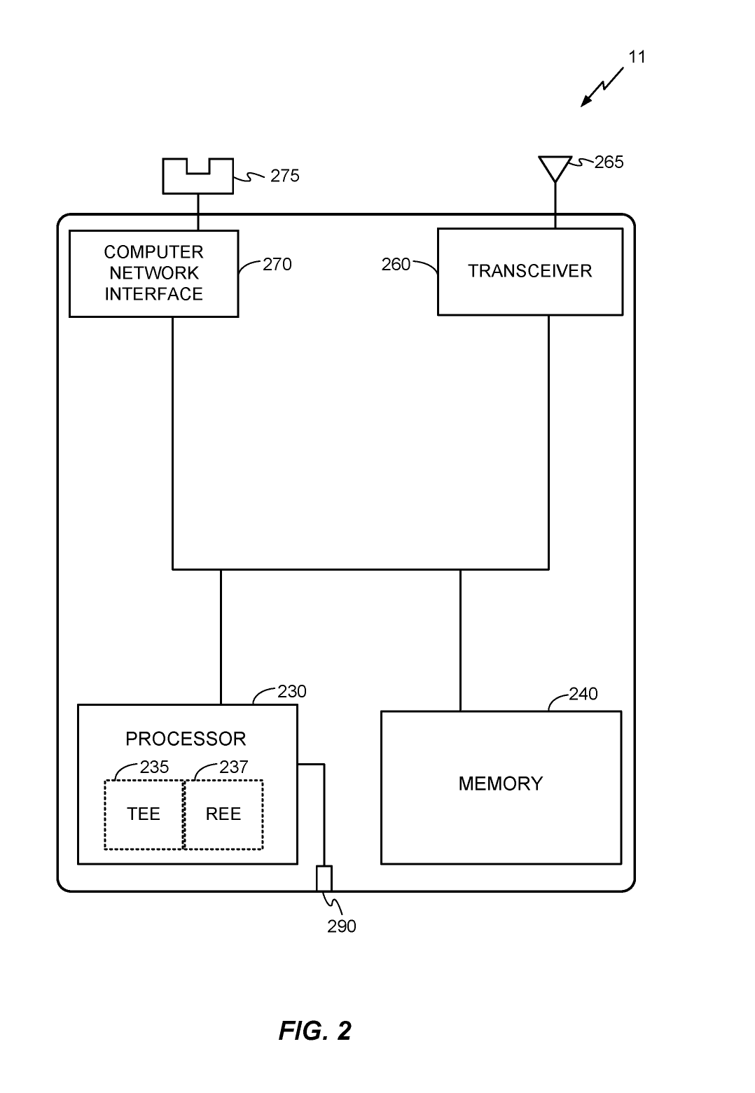

A factory reset is a hard reset of the computing device 11. Generally, a factory reset will restore the computing device 11 to an original state as if it were newly manufactured. For example, the factory reset may restore the content of a memory (e.g., the memory 240 as described below with regard to FIG. 2) of the computing device 11 substantially to a factory state, i.e., the state of the computing device 11 after manufacturing and prior to storage of information on the computing device 11 by a user of the computing device (i.e., storage of user data). The factory reset may erase the user data and retain original equipment manufacturer (OEM) data on the computing device 11. The user data is information stored and/or installed on the computing device 11 after the computing device 11 has left a manufacturing facility. For example, user data may include user application data such as include contact lists, photographs, notes, email, text messages, user identification information (e.g., social security number, financial information, camera images, fingerprint information, etc.), user context information (e.g., maps, location information, Internet search information, etc.), etc. User data may also include information belonging to an employer or enterprise such as patient medical records, client legal documents, technical disclosures, sales forecasts, business information, stock information, etc.

In an implementation, the server 18 may be configured to provide a remote factory reset signal comprising factory reset instructions (e.g., factory reset commands) to the computing device 11. The server 18 may provide the remote factory reset signal via the wireless communication network 16 and/or the computer network 15. The remote factory reset signal may include factory reset instructions executable by a processor (e.g., the processor 230 as described below with regard to FIG. 2) of the computing device 11. The server 18 may provide the remote factory reset signal via the wireless communication network 16 and/or the computer network 15. In various implementations, the remote factory reset signal may be non-overridable or may be overridable by the computing device 11. The non-overridable remote factory reset signal may trigger the hard reset of the computing device 11. The overridable remote factory reset signal may be configured to allow the computing device 11 to determine compliance with the factory reset signal. In this case, the factory reset signal may be a factory reset request and the computing device 11 may or may not respond to the factory request by implementing the hard reset.

A variety of computing device usage situations may implement the remotely issued factory reset request or command. For example, a user of the computing device 11 may be a hospital employee with access to patient records. The hospital employee may store the patient records on the computing device 11. Upon termination of employment at the hospital, the termination agreement may include an agreement for the user of the computing device 11 to delete all patient records from the computing device 11. Such an erasure may be a legal obligation for the hospital and/or the hospital employee. As another example, the computing device 11 may be stolen or lost. The rightful user may want to access a remote server associated with the computing device 11 to do a remote hard reset of the computing device 11.

Referring to FIG. 2, with further reference to FIG. 1, a block diagram of hardware components of the computing device 11 of FIG. 1 is shown. A quantity of each component in FIG. 2 is an example only and other quantities of each, or any, component could be used. The computing device 11 includes a processor 230, a memory 240, a transceiver 260, an antenna 265, a computer network interface 270, a wired connector 275, and, optionally, a factory reset switch 290. The components 230, 240, 260, 265, 270, 275, and 290 are communicatively coupled (directly and/or indirectly) to each other for bi-directional communication. Although shown as separate entities in FIG. 2, the transceiver 260 and the computer network interface 270 may be combined into one or more discrete components and/or may be part of the processor 230.

The processor 230 is a physical processor (i.e., an integrated circuit configured to execute operations on the computing device 11 as specified by software and/or firmware). The processor 230 may be an intelligent hardware device, e.g., a central processing unit (CPU), one or more microprocessors, a controller or microcontroller, an application specific integrated circuit (ASIC), a general-purpose processor, a digital signal processor (DSP), a field programmable gate array (FPGA) or other programmable logic device, a state machine, discrete gate or transistor logic, discrete hardware components, or any combination thereof designed to perform the functions described herein and operable to carry out instructions on the computing device 11. The processor 230 may be one or more processors and may be implemented as a combination of computing devices (e.g., a combination of DSP and a microprocessor, a plurality of microprocessors, one or more microprocessors in conjunction with a DSP core, or any other such configuration). The processor 230 along with memory 240 may be components of a system-on-chip (SoC). The processor 230 may include multiple separate physical entities that may be distributed in the computing device 11. The processor 230 supports a system-wide trusted execution environment (TEE) 235 security platform. Example implementations of the TEE 235 include, but are not limited to, Open Source TEE (OP-TEE) and QUALCOMM® Secure Execution Environment (QSEE), Intel® TXT, and AMD® Secure Execution Environment. The TEE security platform partitions hardware and software resources of the processor 230 and the memory 240 to create a secure world processing environment and a non-secure world processing environment. The non-secure world processing environment is typically referred to as a Rich Execution Environment (REE) 237. The TEE 235 and the REE 237 may be embedded in one processor or in separate processors. The TEE 235 is a security focused execution environment designed to store and manipulate sensitive information and to keep this information private from the REE 237. The REE 237 interacts with the user of the computing device 11 via a high level operating system (HLOS) (e.g., iOS®, Android®, Windows®, Blackberry®, Chrome®, Linux®, Symbian®, Palm®, etc.).

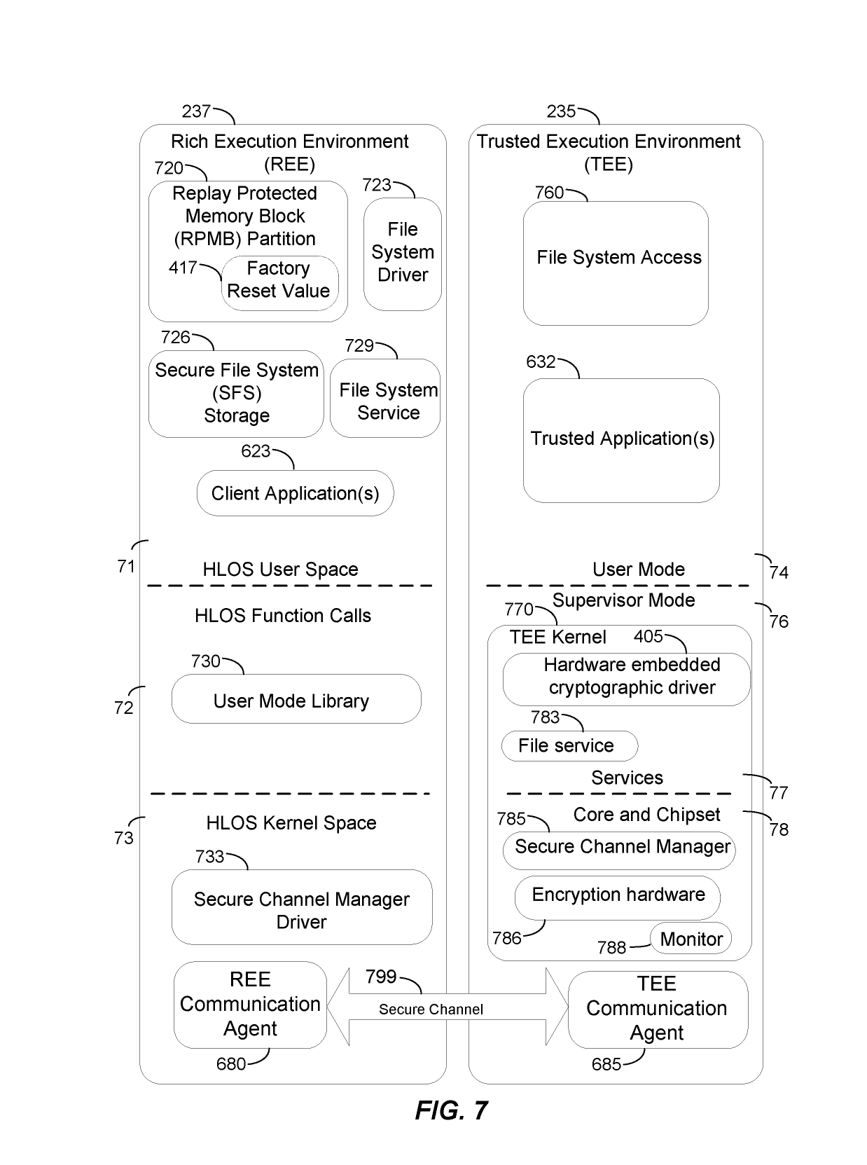

The processor 230 is operably coupled to the memory 240. The processor 230 either alone, or in combination with the memory 240, provides means for performing functions as described herein, for example, executing code or instructions stored in the memory 240. The memory 240 includes a non-transitory, processor-readable storage medium that stores processor executable and processor-readable instructions (i.e., software code) that are configured to, when executed, cause the processor 230 to perform various functions described herein (although the description may refer only to the processor 230 performing the functions). Alternatively, the software code may not be directly executable by the processor 230 but configured to cause the processor 230, e.g., when compiled and executed, to perform the functions. The memory 240 may include, but is not limited to, RAM, ROM, flash, disc drives, fuse devices, etc. The memory 240 may be long term, short term, or other memory associated with the computing device 11 and is not to be limited to any particular type of memory or number of memories, or type of media upon which memory is stored. One or more portions of the memory 240 may be a secure portion of the memory 240. As described in further detail below with regard to FIG. 7, the TEE 235 may store information in and/or retrieve information from the secure portion of the memory 240. The REE 237 may facilitate storage and retrieval of information by the TEE 235 in and/or from the secure portion of the memory 240. However, the REE 237 may not read or otherwise utilize information stored in the secure portion of the memory 240.

The transceiver 260 may send and receive wireless signals via the antenna 265 over one or more wireless networks, for example, the wireless communication network 16 in FIG. 1. The computing device 11 is illustrated as having a single transceiver 260. However, the computing device 11 can alternatively have multiple transceivers 260 and/or antennas 265 to support multiple communication standards such as Wi-Fi, Code Division Multiple Access (CDMA), Wideband CDMA (WCDMA), Long Term Evolution (LTE), Bluetooth, etc. The transceiver 260 may be further configured to enable the computing device 11 to communicate and exchange information, either directly or indirectly with other communications network entities (e.g., the server 18, the communication network access device 12).

The wired connector 275 may enable a wired connection between the computing device 11 and the computer network access device 14 via the computer network interface 270. The computer network interface 270 may include appropriate hardware, including one or more processors (not shown), to couple to and communicate with, for example, the computer network access device 14 and the computer network 15. The computer network interface 270 may include a network interface card (NIC) to enable Internet protocol (IP) communication. Additionally or alternatively, the communicative coupling between the computing device 11 and the computer network 15 may be via a wireless connection (e.g., via the transceiver 260 and the antenna 265).

The factory reset switch 290 may provide a local factory reset signal to the processor 230. The local factory reset signal may trigger the processor 230 to perform a factory reset process in response to the local factory reset signal. Although one factory reset switch 290 is shown for simplicity, the computing device 11 may include multiple factory reset switches. For example, a user may push or otherwise activate one or more factory reset switches 290 and thereby cause the factory reset switch to provide the local factory reset signal to the processor 230. In various implementation, the user may activate one or more factory reset switches in combination with activating other switches (e.g., an on/off switch) and/or sensors (e.g., a user identification sensor, a touch screen sensor, etc.) of the computing device 11 in order to cause the factory reset switch to provide the local factory reset signal to the processor 230. The local factory reset signal is generated at the computing device 11 in contrast to the remote factory reset signal which is generated at a remote server (e.g., the server 18).

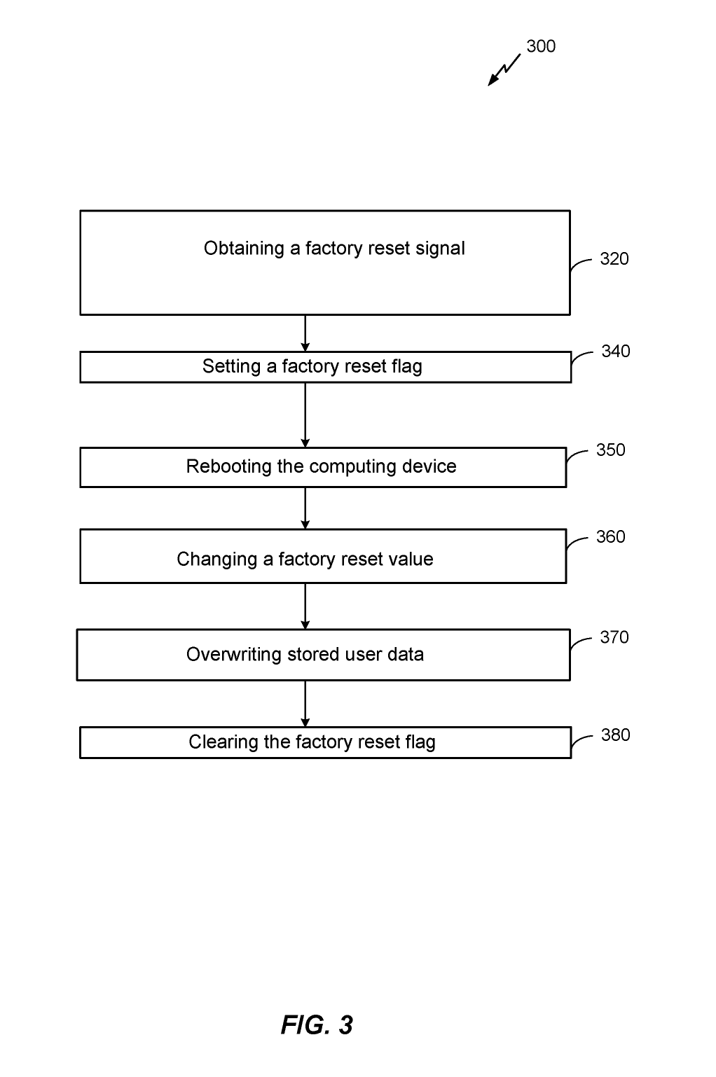

Referring to FIG. 3, with further reference to FIGS. 1-2, a block diagram of an example of a factory reset process is shown. The factory reset process 300 is an example only and not limiting of the disclosure. The factory reset process 300 can be altered, e.g., by having stages added, removed, rearranged, combined, and/or performed concurrently.

At stage 320, the factory reset process 300 includes obtaining a factory reset signal. In various implementations, obtaining the factory reset signal includes receiving the remote factory reset signal and/or receiving the local factory reset signal. For example, the processor 230 may receive the remote factory signal and/or receive the local factory reset signal. A remote entity (e.g., the server 18 or another computing device 11) may send the remote factory reset signal. In an embodiment, the remote entity may send the remote factory reset signal based on or in response to particular operating conditions of the computing device. As a further example, the processor 230 may receive the local factory reset signal generated at the computing device 11. The computing device 11 may generate the local factory reset signal based on or in response to particular operating conditions of the computing device. The particular operating conditions triggering the remote factory reset signal and/or the local factory reset signal may include a user input to the computing device 11, a setting of the computing device 11, a location and/or context of the computing device 11, a battery or other hardware event on the computing device 11, an authentication or other security event on the computing device 11, etc. Further, the particular operating conditions triggering the remote factory reset signal and/or the local factory reset signal may be based on a policy for the computing device 11 (e.g., a security policy, a privacy policy, a geofence policy, a user authentication policy, a lost device policy, etc.). In an implementation, the remote entity may send the remote factory reset signal in response to a request from the user of the computing device 11 and/or a request from an enterprise associated with the computing device 11. In a further implementation, the computing device 11 may generate the local factory reset signal in response to the request from the user and/or the enterprise associated with the computing device 11.

At stage 340, the factory reset process 300 includes setting a factory reset flag. For example, the processor 230 may set the factory reset flag by storing a value in the memory 240. In an implementation, the processor 230 may set the factory reset flag via the TEE 235. The TEE 235 may store the factory reset flag in a secure portion of the memory 240. The factory reset flag may be a stored register value indicative of initiation of the factory reset process by the processor 230.

At stage 350, the factory reset process 300 includes rebooting the computing device. For example, the processor 230 may execute instructions including pre-boot loader instructions, boot-loader instructions, operating system (OS) kernel instructions, and OS instructions in order to reboot the computing device 11.

At stage 360, the factory reset process 300 includes changing a factory reset value (FR value). For example, the processor 230 may replace a previously stored FR value with a new FR value. One or more of the pre-boot loader instructions, boot-loader instructions, OS kernel instructions, or OS instructions may include instructions to replace the previously stored FR value with the new FR value. As an example, the FR value may be a factory reset counter value incremented or decremented by the processor 230. As further examples, the FR value may be a random number generated by the processor 230 or may be a combination of the random number and the factory reset counter value. The processor 230 may set the FR value in the factory reset counter and/or generate the random number corresponding to the FR value and store the FR value in the memory 240. In an implementation, the TEE 235 may change the FR value. The TEE 235 may store the FR value in the secure portion of the memory 240 such that the FR value may be known to the TEE 235 but not to the REE 237. The processor 230 may store the new FR value in the same memory location as the previously stored FR value. In this manner, the processor 230 may replace the previously stored FR value with the new FR value. The processor 230 may set and/or store the FR value in one or more memory devices with write-once capability including, for example, a replay protected memory block (RPMB), an array of fuse devices, an array of anti-fuse devices, etc. The write-once capability may apply to each bit of the FR value. In this way, the new FR value may not be restored to the previously stored FR value. Changing the FR value may occur at various stages of the booting process. For example, a pre-boot loader, a boot loader, an OS kernel, an OS, etc. may change the FR value. In an implementation, the server 18 may trigger changing the FR value in response to a communicative link for a factory reset signal, as established between the server 18 and the computing device 11.

At the stage 370, the factory reset process 300 includes overwriting stored user data. For example, the processor 230 may check for the factory reset flag. In the presence of this flag, the processor 230 may overwrite the stored user data. For example, the processor 230 may write default values to user data memory locations in order to erase the user data from the computing device 11. Overwriting the user data may return the content of locations in the memory 240 substantially to a factory state. In an implementation, the user data may be in a memory partition location reserved for the user data.

A portion of the user data may persist on the device despite implementation of the factory reset process 300. For example, an unexpected occurrence such as a power failure may interrupt the overwriting of the user data. This may result in an incomplete overwriting of the user data resulting in persistent user data. Further, as the user data is likely to be distributed over a large number of memory locations (e.g., a large number of folders, files, etc.), the processor 230 may not have information as to which user data has been erased and which persists. As another example, a portion of the user data may be stored in a secure file system storage along with OEM data. The overwriting may not be implemented in the secure file system storage, for example, in order to retain OEM data on the device. The user data stored in the secure file system along with OEM data may persist following the factory reset process. As a further example, in a replay attack, a malicious party may copy user data from the computing device 11 prior to the overwriting and subsequently restore this user data to the computing device 11.

At stage 380, the factory reset process 300 includes clearing the factory reset flag. For example, upon completion of the overwriting the user data, the processor 230 may clear the factory reset flag set at the stage 340. In an implementation the processor 230 may clear the factory reset flag via the TEE 235. Optionally, the stage 380 may include storing an overwrite completion flag upon completion of the overwriting of the user data. The processor 230 may store the overwrite completion flag at the computing device 11 and/or may send the overwrite completion flag to the server 18. The server 18 may receive the overwrite completion flag in response to providing the remote factory reset signal. In an implementation the processor 230 may store and/or send the overwrite completion flag via the TEE 235.

Subsequent to the factory reset process 300, resuming usage of the computing device (e.g., by a user of the computing device) may commence with rebooting the computing device 11. For example, the processor 230 may execute a boot loader in order to boot or reboot the computing device 11. Rebooting the computing device 11 after overwriting user data may render the computing device 11 operational in substantially the factory state (e.g., the state of the computing device memory assets after manufacturing and before storage of any user information).

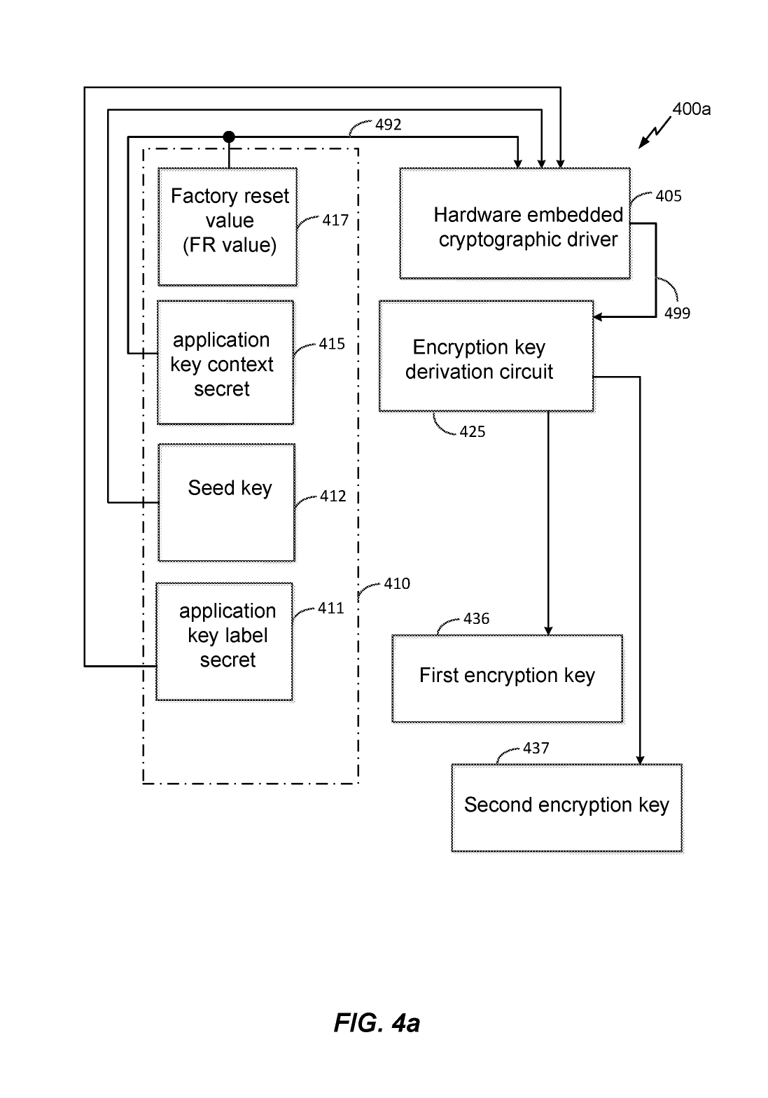

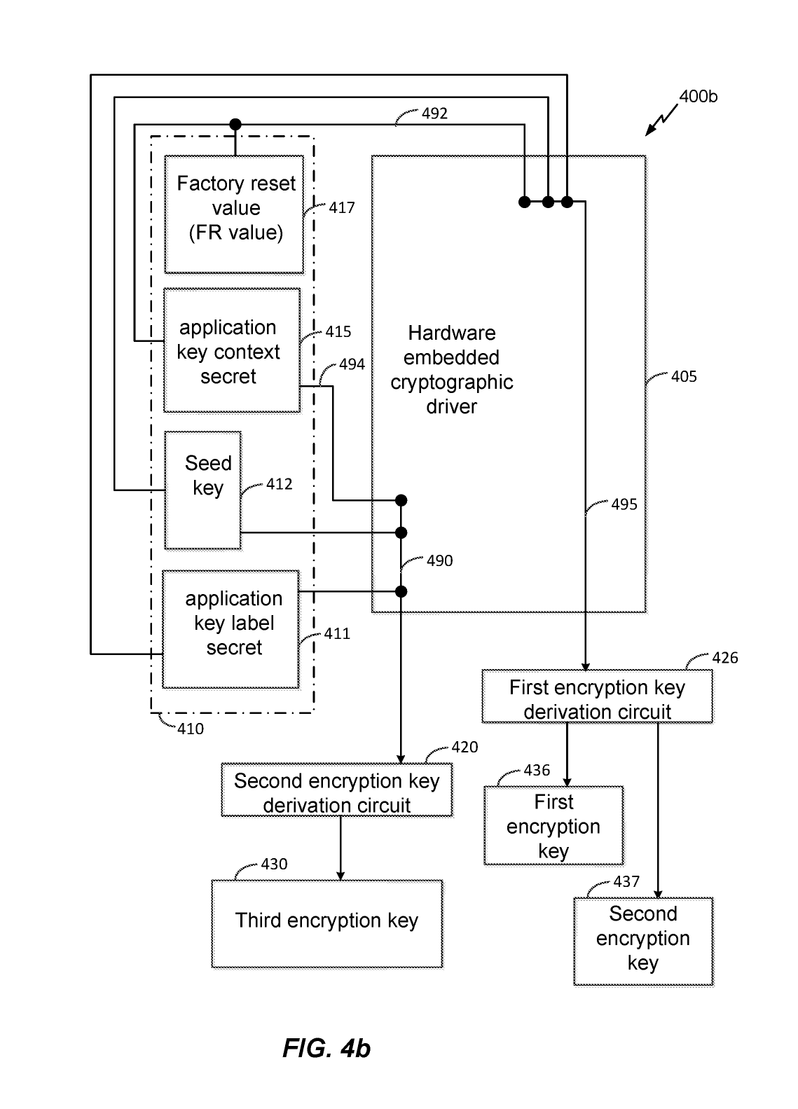

As discussed in further detail below with regard to FIG. 4, the FR value is key material for an encryption key derivation circuit. The processor 230 may encrypt the user data with an encryption key based on the FR value. In order to access and use the user data encrypted with the encryption key based on the FR value, the processor 230 may decrypt this information with the same key used for encryption. However, the FR value changes with each occurrence of the factory reset process 300 (i.e., with each factory reset process implemented on the computing device 11). Once the FR value changes (e.g., from the previously stored FR value to the new FR value), the encryption key based on the FR value changes and may no longer enable decryption of data encrypted based on the previously stored FR value. Information encrypted with an encryption key based on the previously stored FR value (e.g., prior to the factory reset process) is non-decryptable, and therefore inaccessible, once the FR value changes to the new FR value. Therefore, even if the encrypted user data persists on the device despite the implementation of the factory reset process, this encrypted user data may be non-decryptable after the FR value changes. In at least this way, protection of the encrypted user data is independent from (i.e., not reliant on) completion of the factory reset process and/or prevention of the replay attack.

Upon resuming usage of the computing device subsequent to implementing the factory reset process 300, the processor 230 may discover an incomplete factory reset process. For example, the factory reset flag may be uncleared and/or the overwrite completion flag may not be stored (e.g., on the computing device 11 and/or at the server 18). In an implementation, the processor 230 may obtain or request another factory reset signal in order to re-start the factory reset process. However, because the protection of the encrypted user data is not reliant on the completion of the overwriting, the systems and methods according to the disclosure may provide an advantage that restarting the factory reset process in the case of the incomplete overwriting is optional with regard to user data security.

Referring to FIG. 4a, with further reference to FIGS. 1-3, an example of an encryption key derivation system is shown. For example, the processor 230 may implement the encryption key derivation system 400a. In an implementation, the processor 230 may implement the encryption key derivation system 400a via the TEE 235.

The TEE 235 may include a hardware embedded cryptographic driver 405. The hardware embedded cryptographic driver 405 may obtain encryption key material 410 from the secure portion of the memory 240 accessible by the TEE 235. The encryption key material 410 includes an application key label secret 411, a seed key 412, an application key context secret 415 and the FR value 417.

The application key label secret 411 (e.g., label_a) is key material associated with a particular application set by an OEM signed certificate. The application key context secret 415 (e.g., context_a) is key material associated with the particular application set by the TEE 235. The processor 230 may create the application key label secret 411 and/or the application key context secret 415 during runtime of the particular application. The processor 230 may store the application key label secret 411 and/or the application key context secret 415 in RAM in the secure portion of the memory 240 accessible by the TEE 235.

The seed key 412 (e.g., seed_key) is a hardware embedded device key unique to the computing device 11. The seed key 412 may be a shared key (SHK) (e.g., for a secure device) or a dummy key (e.g., for a non-secure device). The OEM may provision the computing device with the seed key 412 during manufacture and store the seed key in the one or more memory devices with write-once capability (e.g., an RPMB, an array of fuse devices, an array of anti-fuse devices, etc. The secure portion of the memory may include the seed key 412. The FR value 417 (e.g., FR_key) is also specific to the computing device 11 and is not shared with or known by another entity or device. As described above with regard to FIG. 3, the processor 230 may set and/or store the FR value 417 in the secure portion of the memory 240 and in the one or more memory devices with write-once capability (e.g., an RPMB, an array of fuse devices, an array of anti-fuse devices, etc.).

The encryption key derivation system 400a may include a key derivation function (KDF) implemented in hardware as the encryption key derivation circuit 425. The encryption key derivation circuit 425 is operably coupled to the hardware embedded cryptographic driver 405. The encryption key derivation circuit 425 may generate a plurality of encryption keys for data storage, with each key of the plurality of encryption keys corresponding to a respective application. The respective application may be a trusted application. The correspondence between the encryption key and the respective application may prevent one application from accessing encrypted data associated with another application. The encryption keys for data storage are encryption keys used to encrypt and decrypt data for storage in the memory 240. The data storage encryption keys are not shared with another device and are not communication protocol encryption keys (e.g., encryption keys used to encrypt data for secure communications between devices).

The hardware embedded cryptographic driver 405 may drive operations of the encryption key derivation circuit 425. The encryption key derivation circuit 425 may implement a first key derivation function, KDF_Key1 to generate the first encryption key 436 (e.g., TEE_App_Key1). The encryption key derivation circuit 425 may have as its input 499, from the hardware embedded cryptographic driver, the application key label secret 411, the seed key 412, and the application key context secret 415. The application key context secret 415 input 492 to the encryption key derivation circuit 425 includes the FR value 417. The FR value 417 for the first encryption key 436 may be a previously stored FR value. The encryption key derivation circuit 425 may generate the first encryption key 436 according to equation (1) below:

TEE_App_Key1=KDF_Key1(seed_key,context_a(FR_key),label_a) (1)

In equation (1), FR_key refers to the previously stored FR value.

The processor 230 may encrypt information (e.g., data and/or data files) with the first encryption key 436 prior to storage in the memory 240. The user data may be associated with the respective application. For example, user data for a credit card application may include a password, account information, user identification information, user operating preferences, etc. The user data is intended to be erased from the computing device 11 during the factory reset process but, as discussed above, all or a portion of the user data may persist on the computing device 11 despite the factory reset process. In an implementation, the processor 230 may encrypt information associated via the TEE 235 prior to passing the data and/or data files from the TEE 235 to the REE 237 for storage.

The processor 230 may decrypt the stored information with the same key (e.g., TEE_App_Key1) used for encryption. Therefore, a change to the first encryption key 436 may disable decryption of the stored information. Because the first encryption key 436 is based on the FR value 417, encryption of data with the first encryption key 436 may render this data non-decryptable, and therefore inaccessible, once the previously stored FR value changes to a new FR value during the factory reset process. The encryption key derivation circuit 425 may generate the first encryption key 436 based on the previously stored FR value.

The encryption key derivation circuit 425 may generate the second encryption key 437 (e.g., TEE_App_Key2) based on a newly stored FR value. Information encrypted using the first encryption key 436 prior to the factory reset process is non-decryptable using the second encryption key 437 subsequent to the factory reset process. For example, the encryption key derivation circuit 425 may generate the second encryption key 437 according to equation (2) below:

TEE_App_Key2=KDF_Key1(seed_key,context_a(FR_key),label_a) (2)

In equation (2), FR_key refers to the newly stored FR value. The first encryption key 436 and the second encryption key 437 are data storage keys.

Referring to FIG. 4b, with further reference to FIGS. 1-4a, a further example of an encryption key derivation system is shown. For example, the processor 230 may implement the encryption key derivation system 400b. In an implementation, the processor may implement the encryption key derivation system 400b via the TEE 235. The encryption key derivation system 400b may include at least two key derivation functions (KDF) (e.g., KDF_Key1 and KDF_Key2) implemented in hardware. The encryption key derivation circuit 425 may be a first encryption key derivation circuit 426. The encryption key derivation system 400b may further include a second encryption key derivation circuit 420. The first encryption key derivation circuit 426 and the second encryption key derivation circuit 420 may be operably coupled to the hardware embedded cryptographic driver 405. The hardware embedded cryptographic driver 405 may access a portion of the encryption key material 410 corresponding to either first input 495 to the first encryption key derivation circuit 426 or to second input 490 to the second encryption key derivation circuit 420.

The second encryption key derivation circuit 420 may generate a third encryption key 430 (e.g., TEE_App_Key3). The second encryption key derivation circuit 420 implements a second key derivation function, KDF_Key2 and has its input the application key label secret 411, the seed key 412, and the application key context secret 415. The application key context secret 415 input 494 to the second encryption key derivation circuit 420 excludes the FR value 417 (i.e., the input to the second encryption key derivation circuit 420 excludes the previously saved FR value and excludes the new FR value). In contrast, the application key context secret 415 input 492 to the encryption key derivation circuit 425 includes the FR value 417. The second encryption key derivation circuit 420 generates the third encryption key 430 according to equation (3) below:

TEE_App_Key3=KDF_Key2(seed_key,context_a,label_a) (3)

The third encryption key 430 is a data storage encryption key.

The processor 230 may encrypt information (e.g., data and/or data files) with the appropriate data storage key prior to storage in the memory 240. The processor 230 may associate data storage key information with each application file or trusted application file. The data storage key information may be indicative of the appropriate data storage key. In various implementations, the data storage key information may be one or more of a decorator in the file name, a flag stored when the file is generated, and/or metadata associated with the file. The decorator may be added to the file name when storage of file is requested. The second encryption key derivation circuit 420 and the first encryption key derivation circuit 426 may each generate a plurality of data storage keys. A respective application may correspond to at least two keys with at least one of the at least two keys being generated by the second encryption key derivation circuit 420 and at least one of the at least two keys being generated by the first encryption key derivation circuit 426. The respective application may be a trusted application.

The processor 230 may use the third encryption key 430 to generate encrypted data that is decryptable after factory reset process. Because the third encryption key 430 is not based on the FR value 417, the data encrypted with this key may remain decryptable after the factory reset. For example, the processor 230 may use the third encryption key 430 to encrypt OEM data. The OEM data is provisioned by the manufacturer and is associated with applications provided on the device at the time of purchase and may be associated with the application provider. For example, if the manufacturer of the computing device 11 contracts with a credit card company to offer a credit card application on the computing device 11, the OEM data may be generic information associated with the credit card company and not associated with a particular user of the computing device 11. Such OEM data may include, for example, business market location information (e.g., North America, France, United Kingdom, China, etc.), language information, website information (e.g., www.creditcardcompanyname.com, www.creditcardcompanyname.fr, or www.creditcardcompanyname.us, etc.), etc. The OEM data may be intended to persist on the computing device 11 after the factory reset process and to remain decryptable after the factory reset process. In an implementation, the processor 230 or the TEE 235 may use the third encryption key 430 to encrypt non-private user data associated with the respective application and/or with the computing device 11. In such an implementation, the non-private user data may remain decryptable after the factory reset process.

The processor 230 may use the first encryption key 436 to encrypt the user data. Because the first encryption key 436 is based on the previously stored FR value, encryption of data with the first encryption key 436 may render this data non-decryptable, and therefore inaccessible, once the previously stored FR value changes to the new FR value during the factory reset process. For the example above of the credit card application, the user data may include a password, account information, user identification information, user operating preferences, etc. The user data is intended to be erased from the computing device 11 during the factory reset process but, as discussed above, all or a portion of the user data may persist on the computing device 11 despite the factory reset process.

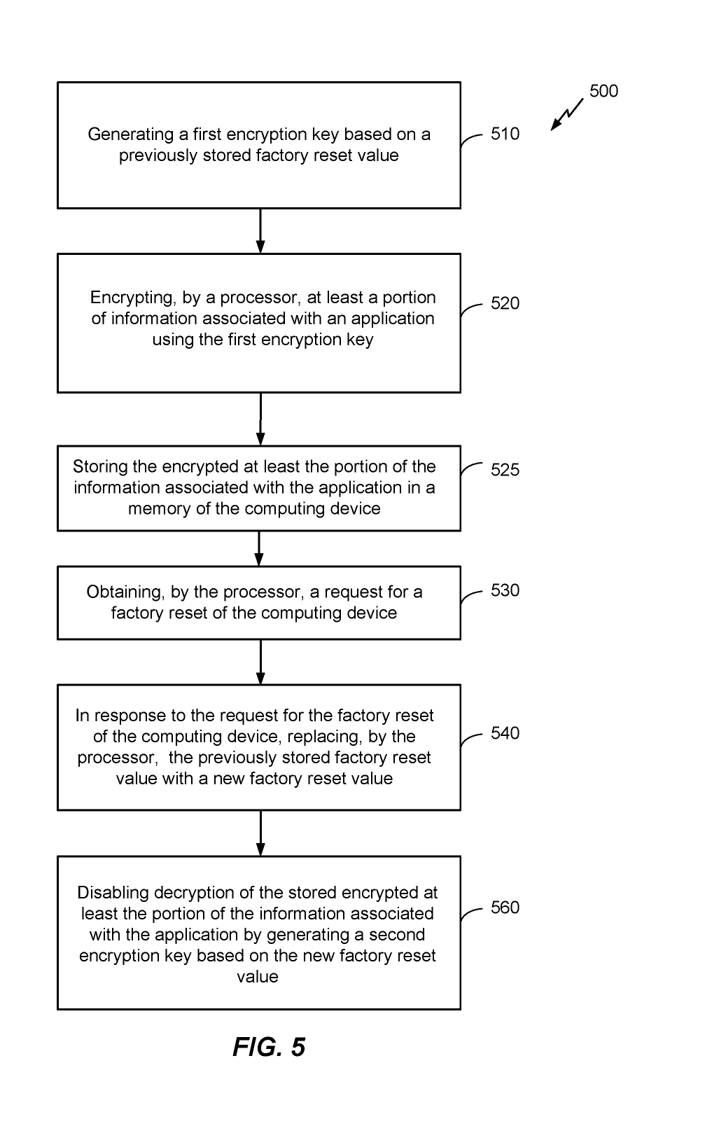

Referring to FIG. 5, with further reference to FIGS. 1-4b, a block diagram of an example of a method of protecting information stored on a computing device is shown. The method 500 is, however, an example only and not limiting. The method 500 can be altered, e.g., by having stages added, removed, rearranged, combined, and/or performed concurrently.

At stage 510, the method 500 includes generating a first encryption key based on a previously stored factory reset value. For example, the encryption key derivation circuit 425 of the processor 230 may generate the first encryption key 436. The first encryption key 436 is a data storage encryption key used to encrypt and decrypt data stored in the memory 240. The previously stored factory reset value corresponds to the FR value 417. In various implementations, the previously stored FR value may be a factory reset counter value, a random number, or a combination thereof. The previously stored FR value may be stored, for example, in a secure portion of the memory 240. The secure portion of the memory 240 may include one or more memory devices with write-once capability such as, for example, a RPMB or an array of fuse and/or anti-fuse devices. In an implementation, the TEE 235 may generate the previously stored FR value and may store this value in the secure portion of the memory 240. The secure portion of the memory 240 may be accessible by the TEE 235 but inaccessible by the REE 237. In an embodiment, the stage 510 may include generating a third encryption key 430 based on key material that excludes the FR value 417. For example, the first encryption key derivation circuit 426 may generate the first encryption key 436 and the second encryption key derivation circuit 420 may generate the third encryption key 430. In a further embodiment, the stage 510 may include generating one or more encryption keys corresponding to one or more respective applications. For example, each application and/or each trusted application may correspond to a pair of keys, the pair of keys including the first encryption key 436 and the third encryption key 430.

At stage 520, the method 500 includes encrypting, by a processor, at least a portion of information associated with an application using the first encryption key. For example, the processor 230 may encrypt user information associated with a respective application using the first encryption key 436 based on the previously stored FR value. In an implementation, the TEE 235 may encrypt the user information. The information associated with the application may include non-private user information, private user information, and OEM information. The processor may encrypt the private user information and/or the non-private user information using the first encryption key 436. In an embodiment, the processor 230 may encrypt the OEM information using the third encryption key 430 (e.g., the data storage encryption key that is not based on the FR value 417) and may encrypt the user information using the first encryption key 436 (e.g., the data storage encryption key that is based on the FR value 417).

At stage 525, the method 500 includes storing the encrypted at least the portion of the information associated with the application in a memory of the computing device. For example, the processor 230 may store the encrypted information in the memory 240. In an implementation, the TEE 235 may store the encrypted information in a secure portion of the memory 240.

At stage 530, the method 500 includes obtaining, by the processor, a request for a factory reset of the computing device. For example, the processor 230 may receive a remote factory reset signal from a remote server (e.g., the server 18). As a further example, the processor may receive a local factory reset signal generated at the computing device 11. In response to obtaining the request for the factory reset of the computing device, the method 500 may include rebooting the computing device.

At stage 540, the method 500 includes, in response to the request for the factory reset of the computing device, replacing, by the processor, the previously stored factory reset value with a new factory reset value. Replacing the previously stored factory reset value with the new factory reset value changes the FR value 417 input to the hardware embedded cryptographic driver 405. For example, the processor 230 may generate the new FR value and replace the previously stored FR value with the new FR value. The processor 230 may store the new FR value, for example, in the secure portion of the memory 240 including the one or more memory devices with write-once capability. In various implementations, the new FR value may be a factory reset counter value, a random number, or a combination thereof. The processor 230 may store the new FR value, for example, in a secure portion of the memory 240. The secure portion of the memory 240 may include one or more memory devices with write-once capability such as, for example, a RPMB or an array of fuse devices. In an implementation, the TEE 235 may generate the new FR value and may store this value in the secure portion of the memory 240 to replace the previously stored FR value. The secure portion of the memory 240 may be accessible by the TEE 235 but inaccessible by the REE 237. The processor 230 may not restore the new FR value to a previously stored value (e.g., the factory counter value, the random number, or the combination thereof) in the memory devices with write-once properties. In an embodiment, the TEE 235 may store the new FR value and the secure portion of the memory 240 may be accessible by the TEE 235 and inaccessible by the REE 237. In an implementation, rebooting the computing device may include replacing the previously stored FR value during execution of the booting firmware and/or software (e.g., the pre-boot loader, the boot loader, the OS kernel, etc.).

At stage 560, the method 500 includes disabling decryption of the stored encrypted at least the portion of the information associated with the application by generating a second encryption key based on the new factory reset value. Changing the FR value 417 from the previously stored value to the new value automatically alters the output (e.g., the first encryption key 436) of the encryption key derivation circuit. Thus an encryption key generated prior to the change of the FR value 417 (i.e., the first encryption key 436 based on the previously stored FR value) expires in response to the change in the FR value. The second encryption key 437 based on the new FR value replaces the first encryption key 436 based on the previously stored FR value. Information encrypted using the first encryption key 436 is only decryptable with the first encryption key 436. Therefore, replacing the first encryption key 436 with the second encryption key 437 disables the decryption of this information. The stored encrypted at least the portion of the information associated with the application may be previously stored information persisting on the computing device after the factory reset process. For example, the previously stored information may persist on the computing device 11 after the factory reset process due to an incomplete overwriting of the previously stored information during the factory reset process. As other examples, not limiting of the disclosure, the previously stored information may persist on the computing device 11 after the factory reset process due to a replay attack restoring the information to the computing device or due to the previously stored information being stored in a portion of the memory 240 that was not subject to overwriting during the factory reset process.

The method 500 may provide an advantage over merely erasing an encryption key. As discussed above, erasing information (e.g., during overwriting portion of the factory reset process) such as stored security keys from the computing device 11 may be interrupted and/or may be incomplete. Additionally, the computing device 11 may be the object of the replay attack. Thus encryption keys may persist unintentionally on the computing device 11. Disabling decryption according to the disclosure may provide the advantage of eliminating a reliance on erasure of security keys to provide data security. Therefore, disabling decryption without reliance on erasure of stored user data and/or stored security keys may provide improved privacy and security for the stored user data.

To fulfill a legal obligation from an enterprise to erase information from an electronic device, the enterprise may request attestation that the information is inaccessible on the computing device 11. An indication from the computing device 11 that a factory reset has occurred that includes a change to the FR value according to the disclosure is an attestation that the files are no longer accessible even if they persist on the device because they are no longer decryptable. The attestation to the change of the factory reset key satisfies, for example, a GlobalPlatform® requirement for encrypted files to be non-decryptable, and therefore inaccessible, after the remote server provides the factory reset signal.

Optionally, the method 500 may include retrieving (e.g., reading) encrypted stored information by the processor 230 or by the TEE 235 subsequent to the factory reset of the computing device. The processor 230 may retrieve and decrypt the OEM information using the third encryption key 430. The third encryption key 430 is not based on the FR value 417 and may be unchanged in response to the factory reset process. The processor 230 may retrieve user information that persists on the computing device after the factory reset process and may attempt to decrypt the user information. However, the factory reset process changes the FR value 417 which changes the output of the first encryption key derivation circuit (i.e., the first encryption key 436 is replaced by the second encryption key 437). Therefore, the attempt by the processor 230 to use the second encryption key 437 to decrypt the user information encrypted with the first encryption key 436 may be unsuccessful as this information is non-decryptable with the second encryption key 437. In an embodiment, the processor 230 may generate an indication of non-decryptable user information (e.g., a flag, an error message, etc.) in response to this attempt to decrypt the user information with the changed key.

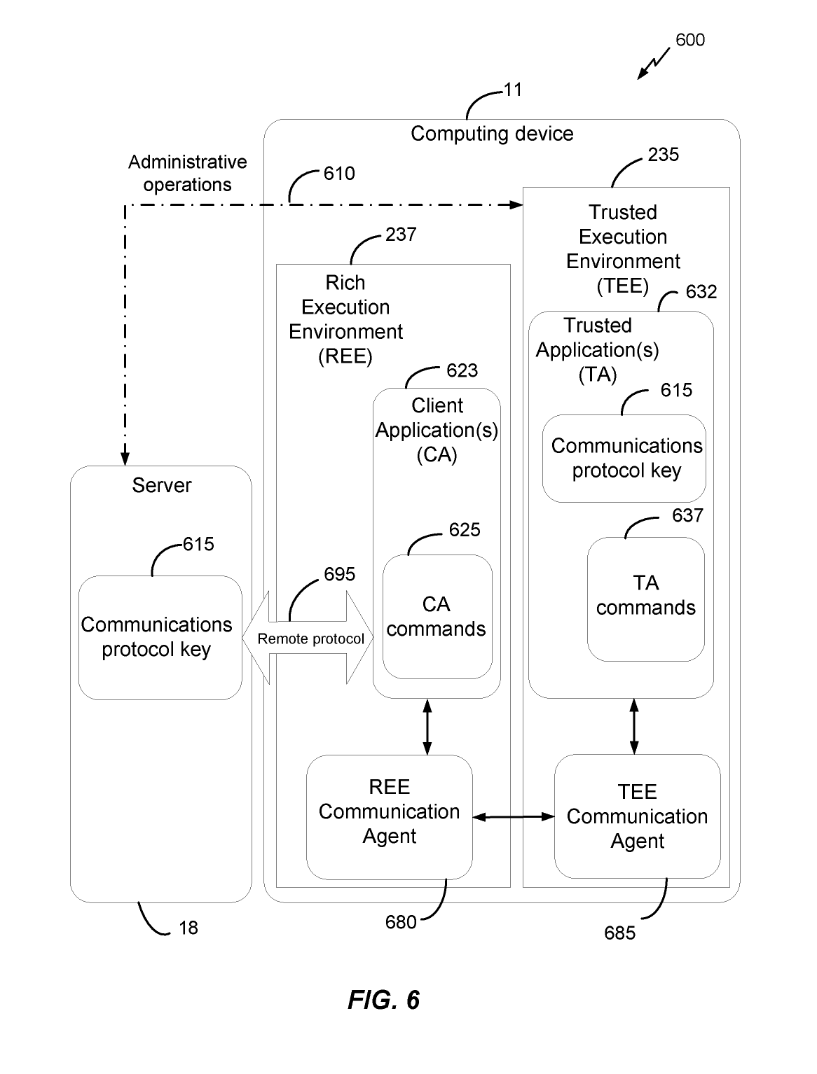

Referring to FIG. 6, with further reference to FIGS. 1-5, a block diagram of an example of a system architecture for secure communications between a server and a computing device is shown. For example, the server 18 may communicate with the computing device 11 via a secure communications channel according to the system architecture 600. In an implementation, the server 18 may send the remote factory reset signal to the computing device 11 via the secure communications channel. Further, the server 18 may send and/or receive the factory reset flag and/or the overwrite completion flag via the secure communications channel. The architecture of FIG. 6 may be implemented by a GlobalPlatform® Trusted Execution Environment Administration Framework (GPTEE framework). In the GPTEE framework, the server 18 is a Trusted Service Manager that may provide the factory reset signal to the computing device 11. The server 18 may perform secure administrative operations 610 via the TEE 235 on the computing device 11. However, in the GPTEE framework, the server 18 may not communicate directly with the TEE 235. Instead, the server 18 may communicate with the TEE 235 via a remote protocol 695 through the insecure environment of the REE 237. The administrative operations 610 may be realized by the communications via the remote protocol 695. For example, trusted application(s) (TA) 632 executing in the TEE 235 may set up a secure communications channel with the server 18 based on the remote protocol 695. The TA 632 is an application running inside the TEE 235 that may export security related functionality to Client Application(s) (CA) 623 executing in the REE 237 and outside of the TEE 235. The server 18 may communicate with the TA 632 via the CA 623. The REE 237 may provide a transport mechanism for the encrypted communications but may be prevented from sniffing (e.g., reading, decrypting, etc.) the encrypted communications. As such the encrypted communications between the server 18 and the TEE 235 merely pass through the REE 237. Such an architecture may prevent, for example, a man-in-the-middle attack by, for example, a CA 623 and/or by a malicious third party utilizing or controlling the REE 237 or encrypted communications between the server 18 and the TEE 235. The secure communications channel may handle communications encrypted based on a communications protocol key 615 known to both the server 18 and the TEE 235. The encrypted communications may follow a path from the server 18 through the CA 623 to a REE Communication Agent 680 to a TEE Communication Agent 685 to the TA 632. The REE Communication Agent 680 and the TEE Communication Agent 685 are HLOS drivers that enable communications between the REE 237 and the TEE 235 according to CA commands 625 and TA commands 637.

Referring to FIG. 7, with further reference to FIGS. 1-6, a block diagram of an example of an execution environment architecture for implementing data protection according to the disclosure is shown. For example, the execution environment architecture shown in FIG. 7 may correspond to a GlobalPlatform® architecture. In such an architecture, the REE 237 and the TEE 235 of the processor 230 may work cooperatively to encrypt data and store the encrypted data on the computing device 11.

The REE 237 may be functionally divided into the HLOS user space 71, the HLOS function calls 72 (e.g., HLOS Native C), and the HLOS kernel space 73. Data storage operations for the computing device 11 may occur in the HLOS user space 71. The HLOS user space 71 may include a replay protected memory block (RPMB) partition 720, for example, in flash memory devices. The RPMB partition 720 may include the FR value 417 and/or the seed key 412. In an implementation, the RPMB may further include the seed key 412. The HLOS user space 71 may further include a file system driver 723, a secure file system (SFS) storage 726, client application(s) 623, and a file system service 729. The HLOS function calls 72 include at least one user mode library 730 (i.e., a function call library). The HLOS kernel space 73 is a privileged portion of the REE 237. The HLOS kernel space 73 provides common services to the client application(s) 623 and administers switching operations between the client application(s) 623. The HLOS kernel space 73 may include the secure channel manager driver 733.

The TEE 235 may be functionally divided into a user mode 74 and a supervisor Mode 76. The user mode 74 may administer the trusted application(s) 632 and the file system access 760. The trusted application(s) 632 may originate from the OEM or may originate from a third-party source. The supervisor mode 76 has higher execution privileges than the user mode 74. For example, encryption operations may occur in the supervisor mode 76. Specifically, these operations may be administered by the TEE kernel 770. The TEE kernel 770 may be functionally divided into services 77 and a core and chipset 78. Services 77 may include the hardware embedded cryptographic driver 405 and the file service 783. The core and chipset 78 may include a secure channel manager 785, encryption hardware 786, and a monitor 788. The encryption hardware 786 may include encryption key derivation circuits (e.g., the second encryption key derivation circuit 420, the first encryption key derivation circuit 426). The supervisor mode 76 may provide common services to the trusted applications 763 including encryption operations. and data communications with the REE 237 via A secure channel 799 between the REE communication agent 680 and the TEE communication agent 685 may enable storage of information by the TEE 235 in the REE 237 (e.g., in the RPMB 720 and/or the SFS storage 726).

In the architecture of FIG. 7, data and file storage operations may occur in the REE 237 and encryption/decryption operations may occur in the TEE 235. For example, the TEE 235 may encrypt user and/or OEM information and store the encrypted information in the SFS storage 726. The TEE 235 may retrieve the encrypted information from the SFS storage 726 for in order to decrypt this information. As a further example, the TEE 235 may store and/or retrieve the FR value 417 and/or the seed key 412 in and/or from the RPMB 720. The TEE 235 may encrypt the user data associated with the Trusted Applications 763 and may store the encrypted data in the REE 237. Similarly, the TEE may retrieve encrypted stored data from the REE 237 and decrypt the stored data. The TEE 235 may encrypt/decrypt data (for example, the user data and/or OEM data associated with the trusted applications 763) using the hardware embedded cryptographic driver 405 and the encryption hardware 786. However, the TEE 235 may not have direct access to the HLOS User Space 71. In order to retrieve the FR value 417, the seed key 412, the encrypted data and/or other information stored in the HLOS User Space 71, the TEE 235 may request that this information be passed back to the TEE 235 via the secure channel 799. The REE 237 may provide pass-through operations by cooperating with the TEE 235 with regard to the secure channel 799. However, the REE 237 may not decrypt, read or otherwise utilize information passing through the secure channel 799 (e.g., the FR value 417, the seed key 412, or the encrypted data). Via the secure channel 799, the TEE 235 may retrieve the encrypted information and decrypt this information for usage by the trusted applications 763. Further, via the secure channel 799, the hardware embedded cryptographic driver 405 of the TEE 235 may retrieve the FR value 417 and/or the seed key 412 for use in encryption/decryption of the user data.

Other embodiments are within the scope of the invention. For example, due to the nature of software, functions described above can be implemented using software, hardware, firmware, hardwiring, or combinations of any of these. Features implementing functions may also be physically located at various locations, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “computer-readable medium,” and “processor-readable medium” as used herein, refer to any medium that participates in providing data that causes a machine to operate in a specific fashion. Using a computer system, various processor-readable media (e.g., a computer program product) might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible processor-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of processor-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

Information and signals may be represented using any of a variety of different technologies and techniques. For example, data, instructions, commands, information, signals, and symbols that may be referenced throughout the above description may be represented by voltages, currents, electromagnetic waves, magnetic fields or particles, optical fields or particles, or any combination thereof.

The methods, systems, and devices discussed above are examples. Various alternative configurations may omit, substitute, or add various procedures or components as appropriate. Configurations may be described as a process which is depicted as a flow diagram or block diagram. Although each may describe the operations as a sequential process, many of the operations can be performed in parallel or concurrently. In addition, the order of the operations may be rearranged. A process may have additional stages not included in the figure.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory processor-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the disclosure. For example, the above elements may be components of a larger system, wherein other rules may take precedence over or otherwise modify the application of the invention. Also, a number of operations may be undertaken before, during, or after the above elements are considered. Also, technology evolves and, thus, many of the elements are examples and do not bound the scope of the disclosure or claims. Accordingly, the above description does not bound the scope of the claims. Further, more than one invention may be disclosed.

What is claimed is:

1. A method of protecting information stored on a computing device, the method comprising:
generating a first encryption key based on a previously stored factory reset value;
encrypting, by a processor, at least a portion of information associated with an application using the first encryption key;
storing the encrypted at least the portion of the information associated with the application in a memory of the computing device;
obtaining, by the processor, a request for a factory reset of the computing device;
in response to the request for the factory reset of the computing device, replacing, by the processor, the previously stored factory reset value with a new factory reset value; and
disabling decryption of the stored encrypted at least the portion of the information associated with the application by generating a second encryption key based on the new factory reset value.

2. The method of claim 1 wherein the previously stored factory reset value and the new factory reset value are each a factory reset counter value, a random number, or a combination thereof.

3. The method of claim 1 comprising:
generating the previously stored factory reset value and the new factory reset value by a trusted execution environment (TEE) of the processor; and
storing the previously stored factory reset value and the new factory reset value, by the TEE, in a secure portion of the memory.

4. The method of claim 1 wherein the information associated with the application comprises user information and OEM information, the method further comprising:
generating a third encryption key based on key material that excludes the previously stored factory reset value;
encrypting the OEM information using the third encryption key; and
encrypting the user information using the first encryption key.

5. The method of claim 4 further comprising, subsequent to the factory reset of the computing device:
decrypting the OEM information using the third encryption key;
attempting to decrypt the user information using the second encryption key; and
generating an indication of non-decryptable user information in response to the attempting to decrypt the user information using the second encryption key.

6. The method of claim 1 wherein obtaining the request for the factory reset of the computing device comprises receiving a remote factory reset signal from a remote server.

7. The method of claim 1 wherein obtaining the request for the factory reset of the computing device comprises receiving a local factory reset signal generated at the computing device.

8. The method of claim 1 comprising:
rebooting the computing device in response to obtaining the request for the factory reset of the computing device; and
replacing the previously stored factory reset value during the rebooting the computing device.

9. A computing device configured to protect information stored on the computing device, the computing device comprising:
a memory; and
a processor communicatively coupled to the memory, the processor configured to:
generate a first encryption key based on a previously stored factory reset value;
encrypt at least a portion of information associated with an application using the first encryption key;
store the encrypted at least the portion of the information associated with the application in the memory;
obtain a request for a factory reset of the computing device;
in response to the request for the factory reset of the computing device, replace the previously stored factory reset value with a new factory reset value; and
generate a second encryption key based on the new factory reset value wherein the generation of the second encryption key based on the new factory reset value disables decryption of the stored encrypted at least the portion of the information associated with the application.

10. The computing device of claim 9 wherein the previously stored factory reset value and the new factory reset value are each a factory reset counter value, a random number, or a combination thereof.

11. The computing device of claim 9 wherein the processor comprises a trusted execution environment (TEE) configured to:
generate the previously stored factory reset value and the new factory reset value; and
store the previously stored factory reset value and the new factory reset value in a secure portion of the memory, wherein the secure portion of the memory comprises one-time writable memory devices.

12. The computing device of claim 9 wherein the processor comprises a trusted execution environment (TEE) configured to:
generate the previously stored factory reset value and the new factory reset value; and
store the previously stored factory reset value and the new factory reset value in a secure portion of the memory, wherein the secure portion of the memory comprises a replay protected memory block (RPMB).

13. The computing device of claim 9 wherein the information associated with the application comprises user information and OEM information, the processor further configured to:
generate a third encryption key based on key material that excludes the previously stored factory reset value;
encrypt the OEM information using the third encryption key; and
encrypt the user information using the first encryption key.

14. The computing device of claim 13 wherein the processor is further configured to, subsequent to the factory reset of the computing device:
decrypt the OEM information using the third encryption key;
attempt to decrypt the user information using the second encryption key; and
generate an indication of non-decryptable user information in response to the attempt to decrypt the user information using the second encryption key.

15. The computing device of claim 9 wherein the processor comprises a hardware embedded cryptographic driver configured to:
obtain encryption key material, wherein the encryption key material includes the previously stored factory reset value or the new factory reset value; and
provide the encryption key material to an encryption key derivation circuit.

16. The computing device of claim 9 wherein the processor is further configured to:
reboot the computing device in response to the request for the factory reset of the computing device; and
replace the previously stored factory reset value during the reboot of the computing device.

17. A non-transitory, processor-readable storage medium having stored thereon processor-readable instructions for protecting information stored on a computing device, the processor-readable instructions configured to cause a processor to:
generate a first encryption key based on a previously stored factory reset value;
encrypt at least a portion of information associated with an application using the first encryption key;
store the encrypted at least the portion of the information associated with the application in a memory;
obtain a request for a factory reset of the computing device;
in response to the request for the factory reset of the computing device, replace the previously stored factory reset value with a new factory reset value; and
generate a second encryption key based on the new factory reset value, wherein the generation of the second encryption key based on the new factory reset value disables decryption of the stored encrypted at least the portion of the information associated with the application.

18. The non-transitory, processor-readable storage medium of claim 17 wherein the processor-readable instructions are further configured to cause the processor to:
generate the previously stored factory reset value and the new factory reset value by a trusted execution environment (TEE) of the processor; and
store the previously stored factory reset value and the new factory reset value, by the TEE, in a secure portion of the memory.

19. The non-transitory, processor-readable storage medium of claim 17 wherein the information associated with the application comprises user information and OEM information and further wherein the processor-readable instructions are further configured to cause the processor to:
generate a third encryption key based on key material that excludes the previously stored factory reset value;
encrypt the OEM information using the third encryption key;
encrypt the user information using the first encryption key; and
subsequent to the factory reset of the computing device,
decrypt the OEM information using the third encryption key;
attempt to decrypt the user information using the second encryption key; and
generate an indication of non-decryptable user information in response to the attempt to decrypt the user information using the second encryption key.

20. The non-transitory, processor-readable storage medium of claim 17 wherein the processor-readable instructions comprise pre-boot loader instructions, boot loader instructions, operating system kernel instructions, and operating system instructions and further wherein at least one of the pre-boot loader instructions, the boot loader instructions, the operating system kernel instructions, or the operating system instructions includes instructions to replace the previously stored factory reset value during a reboot of the computing device in response to the request for the factory reset of the computing device.
